(19) United States
(12) Patent Application Publication
(10) Pub. No.: US 2013/0197914 A1
(43) Pub. Date: Aug. 1, 2013

(54) VOICE ACTIVATED AUDIO CONTROL SYSTEM AND ASSOCIATED METHOD OF USE

(71) Applicants: Timothy Yelvington, McLeansville, NC (US); Edward J. Kennedy, Greensboro, NC (US); Johnny BA Tran, High Point, NC (US); Brandon K. Griffin, Greensboro, NC (US)

(72) Inventors: Timothy Yelvington, McLeansville, NC (US); Edward J. Kennedy, Greensboro, NC (US); Johnny BA Tran, High Point, NC (US); Brandon K. Griffin, Greensboro, NC (US)

(73) Assignee: MicroTechnologies LLC d/b/a MicroTech, Vienna, VA (US)

(21) Appl. No.: 13/359,225

(22) Filed: Jan. 26, 2012

(51) Int. Cl. G10L 11/00

(52) U.S. Cl. 704/275; 704/E11.001

(57) ABSTRACT

A voice activated system for operating electronic devices in an environment includes a microphone for receiving a verbal command that requests the addition of a new voice command, a first processor, that is electrically connected to the microphone, for receiving a customized command input regarding a preexisting user for the voice activated system that should be associated with the new verbal command, input involving a new verbal command, and input involving a system command, where the first processor is then able to receive verbal input to recognize a user, a verbal command, and then determine an associated action, an appropriate command for that action and then generate an associated system command, and a second processor, in electronic communication with the first processor, and two or more electronic devices in an environment, where the second processor is capable of receiving the system command and operating the two or more devices.

### BACKGROUND OF THE INVENTION

There are now numerous devices and systems that are electronically controlled. It would be very helpful to have a system that allows multiple users to operate the system through verbal commands. Each individual user has his or her own vocal style when it comes to issuing commands to an electronic device or system and it would be extremely helpful to have a system that could accommodate an individual's unique approach to controlling devices and systems with verbal commands. Many office environments have at least a portion of their facilities controlled through computer systems. The office may have an HVAC (heating, ventilation, and air conditioning) and teleconferencing solutions controlled by a computer somewhere in the building. In the home, owners may have the lights controlled by a computer in the home. In all of the current methodologies, the control system must be controlled through the use of some sort of display like a laptop or tablet computer. There are many environments where this approach is either inconvenient or even impossible such as in the case where a person in an office wants to dim the lights, but cannot get access to the controlling computer; or the case of a blind person at home that wants to turn up the volume on the television or turn down the thermostat.

The present invention is directed to overcoming one or more of the problems set forth above.

### SUMMARY OF THE INVENTION

This section provides a general summary of the disclosure, and is not a comprehensive disclosure of its full scope or all of its features. The present invention is directed to a voice activated control system and associated method of use.

An aspect of this invention provides a voice activated system for operating electronic devices in an environment. This voice activated system includes a microphone for receiving a verbal command that requests the addition of a new voice command, a first processor, that is electrically connected to the microphone, for receiving a customized command input regarding a preexisting user for the voice activated system that should be associated with the new verbal command, input involving a new verbal command, and input involving a system command, where the first processor is then able to receive verbal input to recognize a user, a verbal command, and then determine an associated action, an appropriate command for that action and then generate an associated system command, and a second processor that is in electronic communication with the first processor and at least two electronic devices in an environment, where the second processor is capable of receiving the system command from the first processor and then activate at least one selected electronic device of the at least two electronic devices to perform a desired system action in response.

Another aspect of this invention provides a method for utilizing a voice activated system for operating electronic devices in an environment. This method includes receiving a verbal command that requests the addition of a new voice command with a microphone that is electrically connected to a first processor, receiving input regarding a preexisting user for the voice activated system that should be associated with the new verbal command, a new verbal command, and a system command with the first processor that is electrically connected to the microphone, receiving verbal input to recognize a user, a verbal command with the microphone that is electrically connected to the first processor, determining an associated action and an appropriate command for that action with the first processor, generating an associated system command with the first processor, receiving the system command from the first processor with a second processor that is in electronic communication with the first processor, and activating a selected electronic device of at least two electronic devices in an environment to perform the desired system command in response.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. For a better understanding of the present invention, reference may be made to the accompanying drawings in which:

FIG. 1 is a schematic of the components that are found in a preferred illustrative, but nonlimiting, embodiment of a voice activated audio control system in accordance with the present invention;

FIG. 2 provides a flowchart that shows the basic features and process steps of a voice activated audio control system in accordance with the present invention;

FIG. 3 provides a flowchart of providing a verbal command of a voice activated audio control system in accordance with the present invention; and

FIG. 4 provides a flowchart of customizing a verbal command of a voice activated audio control system in accordance with the present invention.

Reference characters in the written specification indicate corresponding items shown throughout the drawing figures.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, e.g., devices, have not been described in detail so as to obscure the present invention.

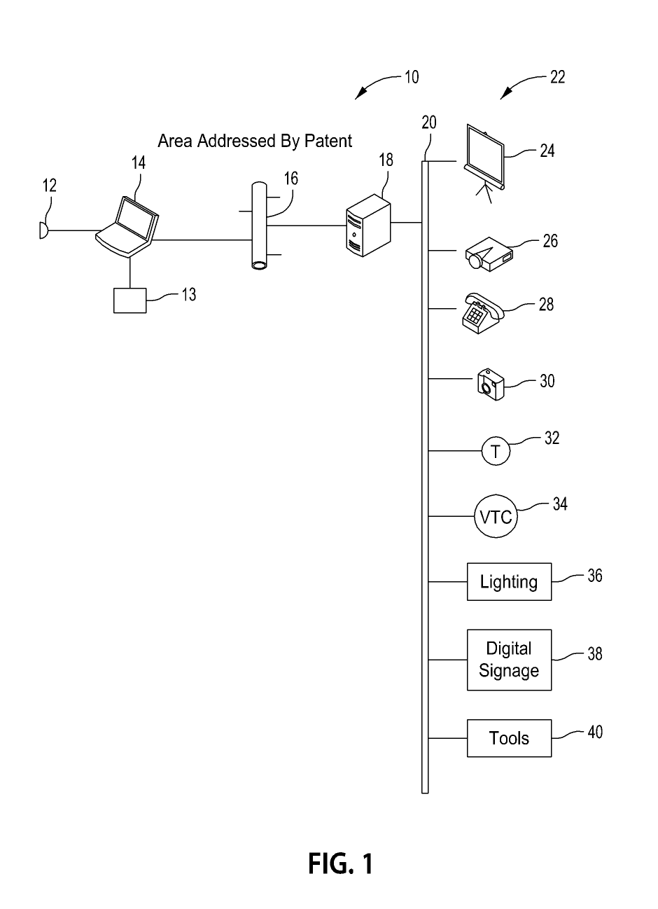

An illustrative, but nonlimiting, embodiment of a voice activated control system in accordance with the principles of this invention is indicated generally as 10 in FIG. 1. This includes a microphone 12 for receiving verbal input and converting the verbal input to an electronic signal. Any of a wide variety of electronic microphone-type devices, which may convert sound waves to digital signals, can suffice for this application. The microphone 12 is electronically connected to a first processor 14 or incorporated therein. This first processor 14 may include any of a wide variety of processors with the preferred embodiment being either a laptop or desktop processor. There is also a speaker 13 for receiving a responsive audio response. This first processor 14 operates as an audible command controller. The first processor 14 is in electronic communication 16 with a second processor 18 that operates as a device control processor. This second processor 18 can include any of a wide variety of computers including, servers, desktop computers, laptop computers, main frame computers, and so forth. This electronic communication 16 is preferably high level conductivity and can include any of a wide variety of electronic communication systems and devices, e.g., WAN, LAN, Internet, Wi-Fi, and so forth. The second processor 18, i.e., device control processor, is electronically connected 20 to a wide variety of electronic devices 22.

This electronic communication 20 can include any of a wide variety of electronic communication systems and devices, e.g., WAN, LAN, Internet, Wi-Fi, and so forth. The electronic devices 22 can include, but are not limited to: electronic multimedia presentation systems 24; electronic projection systems 26, which may include 3-D room animation; telephonic systems 28; video and/or photography systems 30; thermostats for HVAC systems 32; video conferencing and/or telepresence systems 34, e.g., integrated, portable or desktop; lighting system control 36; digital signage 38; and tools 40. The tools may include, but are not limited to: control systems design; acoustic modeling, sound reinforcement and noise masking; streaming, content storage, and delivery; command, control and communications (C3); and collaborative tools.

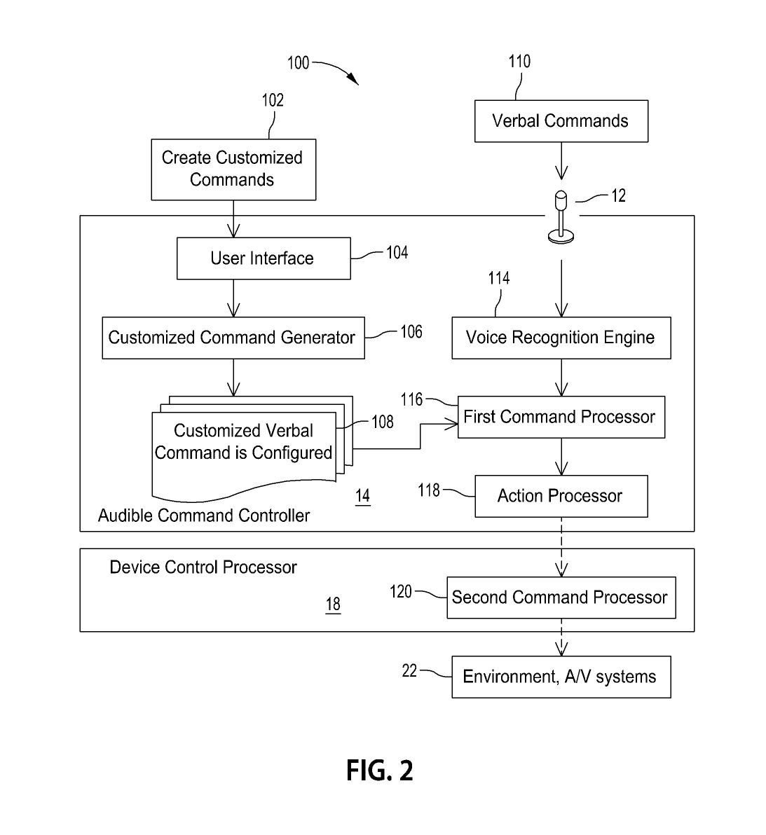

The method of initializing the voice activated audio control system is generally discussed with reference to the flowchart in FIG. 2, generally indicated by numeral 100. In the description of the flowcharts, the functional explanation marked with numerals in angle brackets, <nnn>, will refer to the flowchart blocks bearing that number.

There are two paths utilizing the audible command controller or first processor 14 with the first being to create a customized verbal command(s) <102>, which includes utilizing a user interface <104> and then operate the customized command generator <106>. A customized verbal command is configured <108>, which is then provided to a first command processor <116>.

A verbal command <110>, either preexisting or recently created and configured, is provided to the microphone 12. A voice recognition engine <114> then attempts to correlate the verbal sound into an electronic signal that is recognized by the system. A wide variety of voice recognition engines may suffice with an illustrative, but nonlimiting system, being the KINECT® system from MICROSOFT®. The Microsoft Corporation has a place of business at One Microsoft Way, Redmond, Wash. 98052-6399.

Once the first command processor <116>, recognizes the command, then a proposed action is generated by the action processor <118>. The proposed action is then electronically communicated to the second processor 18 in a second command processor <120>, which is the device control processor for activating any of a wide variety of electronic devices 22, previously referenced above.

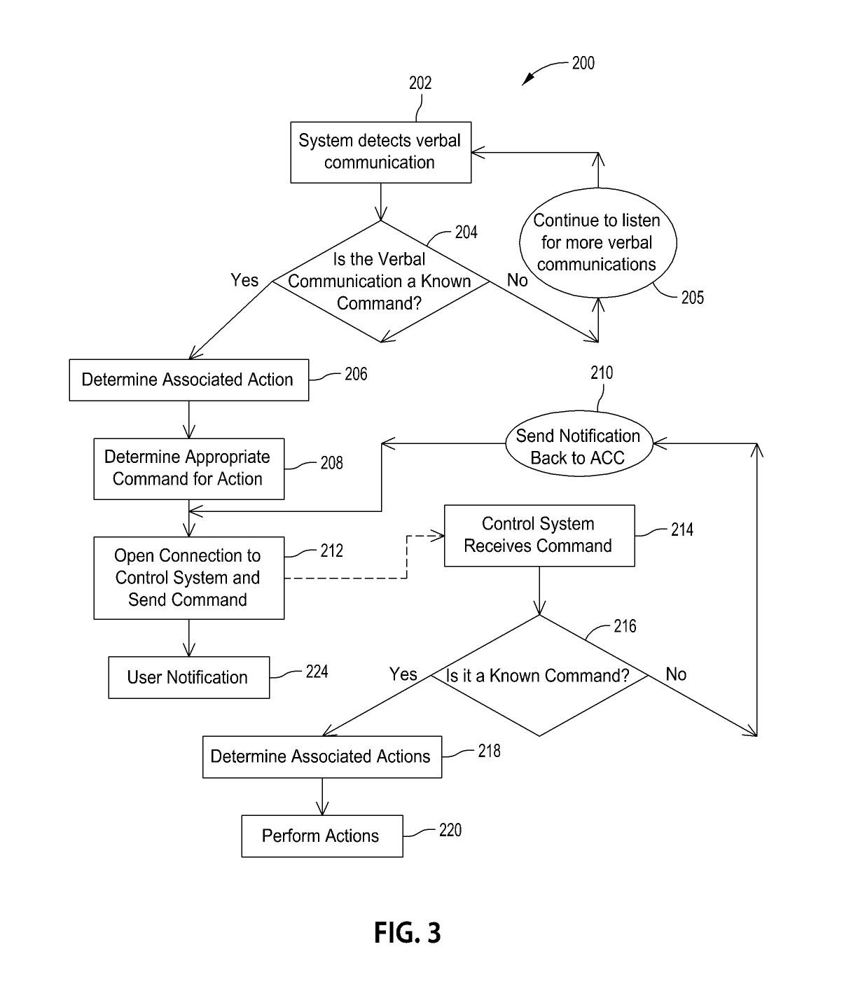

A further breakdown of the verbal command process is detailed in FIG. 3 and illustrated in the flowchart by numeral 200. The first step <202> is for the system to detect verbal communication. Then the determination is made if the verbal communication is a known command <204>. If the determination is that a known command is not present, then the system returns to step <202> to receive additional verbal communication <205>. If a known command is present in the verbal communication then there is a determination as to what action should be associated with the verbal command <206>. There is then a determination made as to what is the appropriate command for action <208>. Upon this determination, there is then an open communication to a control system with a send command <212>. The control system then receives the command <214> and makes a determination if the command is known <216>. If the command is known, then an appropriate action is determined <218> and the action is then performed <220>. If the command is not known <216>, then a notification signal <210> is then sent back to the control system <212> and the user is then notified <224>.

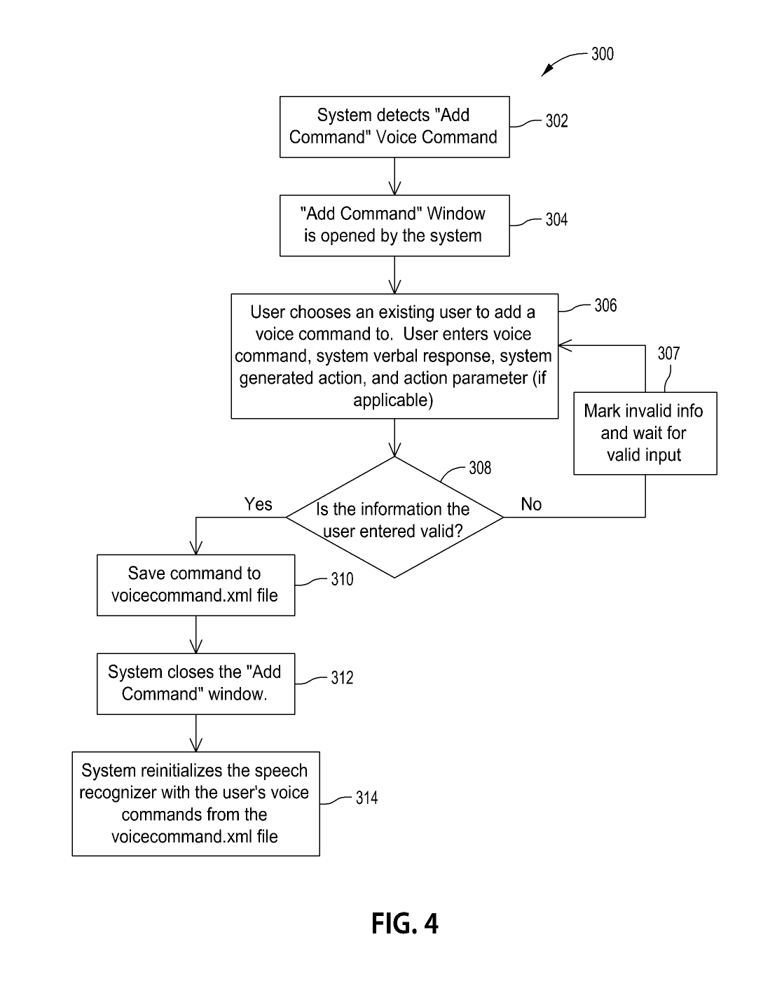

The process for obtaining a customized command is outlined in the flowchart of FIG. 4 that is generally indicated by numeral 300. The first step is for the system to detect an “add command” voice command <302>. Once this is recognized then an “add command” window is opened in the voice activated audio control system 10 <304>. The user can choose an existing user to associate the voice command, this is followed by the desired system generated verbal response, system generated action and an optional action parameter <306>. A determination is then made by the voice activated audio control system 10 whether the inputted information from step <306> is valid in step <308>. If the determination is affirmative, then the information is saved to a file, e.g., voicecommand.xml file, <310>, followed by closing the “add command” window <312>. The system is preferably, but not necessarily reinitialized with the new custom voice commands from the recently created file <314>. If in step <308> there is a determination that the inputted information is not valid <307>, then the process returns to step <306>, where the user can again chose an existing user to associate the voice command, this is followed by the desired computer generated verbal response, computer generated action and an optional action parameter

Furthermore, it should be understood that when introducing elements of the present invention in the claims or in the above description of the illustrative, but nonlimiting, embodiment of the invention, the terms “have,” “having,” “includes” and “including” and similar terms as used in the foregoing specification are used in the sense of “optional” or “may include” and not as “required.” Similarly, the term “portion” should be construed as meaning some or all of the item or element that it qualifies.

Thus, there have been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

What is claimed is:

1. A voice activated system for operating electronic devices in an environment, comprising:
a microphone for receiving a verbal command that requests the addition of a new voice command;
a first processor, that is electrically connected to the microphone, for receiving a customized command input regarding a preexisting user for the voice activated system that should be associated with the new verbal command, input involving a new verbal command, and input involving a system command, wherein the first processor is then able to receive verbal input to recognize a user, a verbal command, and then determine an associated action, an appropriate command for that action and then generate an associated system command; and
a second processor that is in electronic communication with the first processor and a plurality of electronic devices in an environment, wherein the second processor is capable of receiving the system command from the first processor and then activate at least one selected electronic device of the plurality of electronic devices to perform a desired system action in response.

2. The voice activated system for operating electronic devices in an environment in accordance with claim 1, wherein the first processor receives input involving a system generated verbal response that can be outputted to a speaker that is electrically connected to the first processor in response to verbal input received in the microphone.

3. The voice activated system for operating electronic devices in an environment in accordance with claim 1, wherein the plurality of electronic devices is selected from the group consisting of electronic multimedia presentation systems; electronic projection systems, 3-D room animation, telephonic systems, video system, photography system, thermostats for HVAC systems; video conferencing and/or telepresence systems, lighting system control; digital signage, control systems design tool, acoustic modeling tool, sound reinforcement tool, noise masking tool, streaming tool, content storage tool, delivery tool, command, control and communications (C3) tool and a collaborative tool.

4. The voice activated system for operating electronic devices in an environment in accordance with claim 2, wherein the first processor evaluates the selected preexisting user for the voice activated system that should be associated with the new verbal command, the new verbal command, the system generated verbal response, and the system command information for validity.

5. The voice activated system for operating electronic devices in an environment in accordance with claim 4, wherein the first processor requests reentering of the information regarding the selected preexisting user for the voice activated system that should be associated with the new verbal command, the new verbal command, the system generated verbal response, and the system command information if the previously entered information is determined to be invalid.

6. The voice activated system for operating electronic devices in an environment in accordance with claim 4, wherein the first processor saves data in a file involving the selected preexisting user for the voice activated system that should be associated with the new verbal command, the new verbal command, the system generated verbal response, and the system command information upon a determination of validity.

7. The voice activated system for operating electronic devices in an environment in accordance with claim 6, wherein the first processor integrates the saved data file into the voice activated system.

8. The voice activated system for operating electronic devices in an environment in accordance with claim 1, wherein the first processor determines appropriate actions based on the system command information involving control and operation of the plurality of electronic devices.

9. The voice activated system for operating electronic devices in an environment in accordance with claim 8, wherein the second processor performs the determined appropriate actions based on the system command information involving control and operation of the plurality of electronic devices.

10. The voice activated system for operating electronic devices in an environment in accordance with claim 1, wherein the first processor receives input involving an action parameter.

11. A method for utilizing a voice activated system for operating electronic devices in an environment, comprising:
receiving a verbal command that requests the addition of a new voice command with a microphone that is electrically connected to a first processor;
receiving input regarding a preexisting user for the voice activated system that should be associated with the new verbal command, a new verbal command, and a system command with the first processor that is electrically connected to the microphone;
receiving verbal input to recognize a user, a verbal command with the microphone that is electrically connected to the first processor;
determining an associated action and an appropriate command for that action with the first processor;
generating an associated system command with the first processor;
receiving the system command from the first processor with a second processor that is in electronic communication with the first processor; and
activating a selected electronic device of a plurality of electronic devices in an environment to perform the desired system command in response.

12. The method for utilizing a voice activated system for operating electronic devices in an environment in accordance with claim 11, further comprising providing input involving a system generated verbal response that can be outputted to a speaker that is electrically connected to the first processor in response to verbal input received in the microphone.

13. The method for utilizing a voice activated system for operating electronic devices in an environment in accordance with claim 11, wherein the plurality of electronic devices in an environment is selected from the group consisting of electronic multimedia presentation systems;
electronic projection systems, 3-D room animation, telephonic systems, video system, photography system, thermostats for HVAC systems; video conferencing and/or telepresence systems, lighting system control; digital signage, control systems design tool, acoustic modeling tool, sound reinforcement tool, noise masking tool, streaming tool, content storage tool, delivery tool, command, control and communications (C3) tool and a collaborative tool.

14. The method for utilizing a voice activated system for operating electronic devices in an environment in accordance with claim 12, further comprising evaluating the selected preexisting user for the voice activated system that should be associated with the new verbal command, the new verbal command, the system generated verbal response, and the system command information for validity with the first processor.

15. The method for utilizing a voice activated system for operating electronic devices in an environment in accordance with claim 14, further comprising requesting of reentering of the information regarding the selected preexisting user for the voice activated system that should be associated with the new verbal command, the new verbal command, the system generated verbal response, and the system command information if the previously entered information is determined to be invalid with the first processor.

16. The method for utilizing a voice activated system for operating electronic devices in an environment in accordance with claim 14, further comprising saving data in a file involving the selected preexisting user for the voice activated system that should be associated with the new verbal command, the new verbal command, the system generated verbal response, and the system command information upon a determination of validity with the first processor.

17. The method for utilizing a voice activated system for operating electronic devices in an environment in accordance with claim 16, further comprising saving the data file into the voice activated system.

18. The method for utilizing a voice activated system for operating electronic devices in an environment in accordance with claim 11, further comprising determining appropriate actions based on the system command information involving control and operation of the plurality of electronic devices with the first processor.

19. The method for utilizing a voice activated system for operating electronic devices in an environment in accordance with claim 18, further comprising performing the determined appropriate actions based on the system command information involving control and operation of the plurality of electronic devices with the second processor.

20. The method for utilizing a voice activated system for operating electronic devices in an environment in accordance with claim 11, further comprising receiving input involving an action parameter with the first processor.
